(19) United States
(12) Patent Application Publication
(10) Pub. No.: US 2005/0071740 A1
(43) Pub. Date: Mar. 31, 2005

(54) Task extraction and synchronization

(76) Inventors: Lai Theng Chee, Bayan Lepas (MY); Haw Kuang Oh, Georgetown (MY)

Correspondence Address: INTEL CORPORATION, P.O. BOX 5326, SANTA CLARA, CA, 95056-5326, US

(21) Appl. No.: 10/676,686

(22) Filed: Sep. 30, 2003

(51) Int. Cl. G06F 17/00

(52) U.S. Cl. 715/500

(57) ABSTRACT

In one embodiment, a method is provided. The method may include extracting at least one task from a first document, the first document being associated with a first application; extracting at least one other task from a second document, the second document being associated with a second application; and storing each of the at least one task and at least one other task in a task repository.

### FIELD

Embodiments of this invention relate to the field of task extraction and synchronization.

### BACKGROUND

In one task processing technique, a task creator may assign tasks via various applications, and task owners may update these tasks via the various applications. The current approach may pose inefficiencies in that tasks extracted from various applications are not easily manageable. In one prior art example, an owner of a plurality of tasks assigned via several applications manually consolidates the tasks to update them, or otherwise updates the tasks using the applications from which they were assigned. Also, for example, a task creator who may assign tasks via various applications manually tracks the statuses of tasks assigned via the various applications.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a diagram illustrating a system embodiment.

FIG. 2 is a flowchart illustrating operations in an embodiment.

FIG. 3 is a flowchart illustrating operations in an embodiment.

FIG. 4 is a diagram illustrating a system embodiment.

FIG. 5 is a smaller scale view showing the whole formed by the partial views of FIGS. 5A and 5B, and which indicates the positions of the parts shown in FIGS. 5A and 5B.

FIG. 5A and FIG. 5B each illustrate partial views of an operation of an embodiment.

FIG. 6 is a smaller scale view showing the whole formed by the partial views of FIGS. 6A and 6B, and which indicates the positions of the parts shown in FIGS. 6A and 6B.

FIG. 6A and FIG. 6B each illustrate partial views of an operation of an embodiment.

### DETAILED DESCRIPTION

Embodiments of the present invention include various operations, which will be described below. The operations associated with embodiments of the present invention may be performed by hardware components or may be embodied in machine-executable instructions, which may be used to cause a general-purpose or special-purpose processor or logic circuits programmed with the instructions to perform the operations. Alternatively, and/or additionally, some or all of the operations may be performed by a combination of hardware and software.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media / machine-readable medium suitable for storing such instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

The functionality of each component as described below may be implemented in hardware as circuits. As used herein, a circuit that carries out certain functionality may comprise circuitry (which may be a single circuit, or a plurality of circuits), and may be programmed with instructions to perform the functionality. A circuit may comprise a digital circuit, an analog circuit, a state machine, programmable circuitry, and/or an ASIC (application specific integrated circuit). Also, a first circuit may not necessarily be distinct from a second circuit. It is possible that the first and second circuits may contain overlapping circuitry, or that a first circuit and a second circuit may contain the same circuitry. Moreover, it is possible for the two circuits to be embedded in the same component.

Introduction

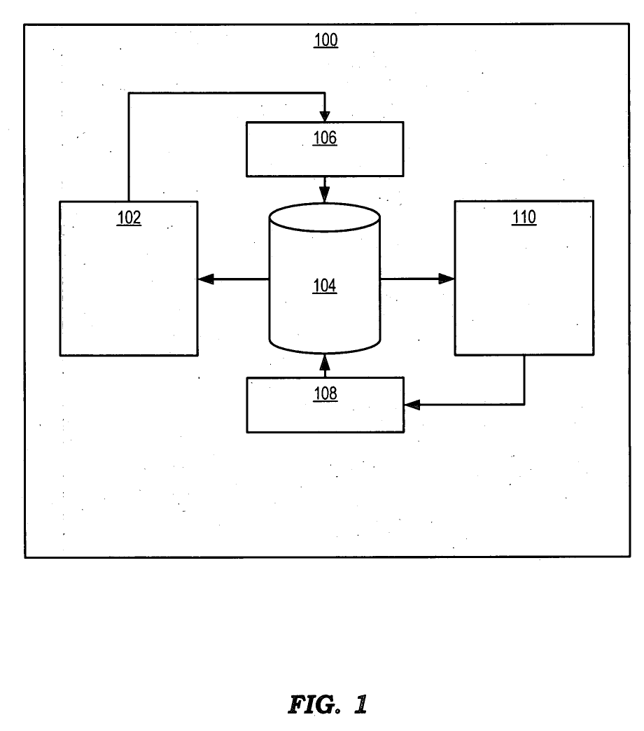

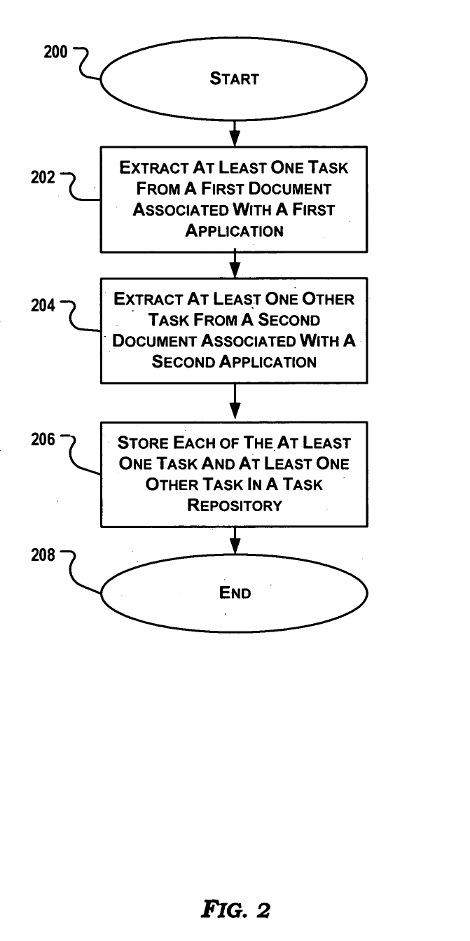

FIG. 1 illustrates a system 100 in accordance with an embodiment of the invention. FIG. 2 illustrates a method in accordance with an embodiment of the invention. The method begins at block 200 and continues to block 202 where a task extractor 106 may extract at least one task from a first document that may be located in memory 102, where the first document may be associated with a first application. At block 204, the task extractor 106 may extract at least one other task from a second document that may be located in memory 102, where the second document may be associated with a second application. As used herein, a document is associated with an application if the document comprises information that may be accessed using the application. At block 206, the task extractor 106 may store the at least one task and at least one other task into at least one task repository 104 (only one shown). Tasks in task repository 104 may be accessed by an application, and managed using documents, such as documents located in memory 110. The method ends at block 208.

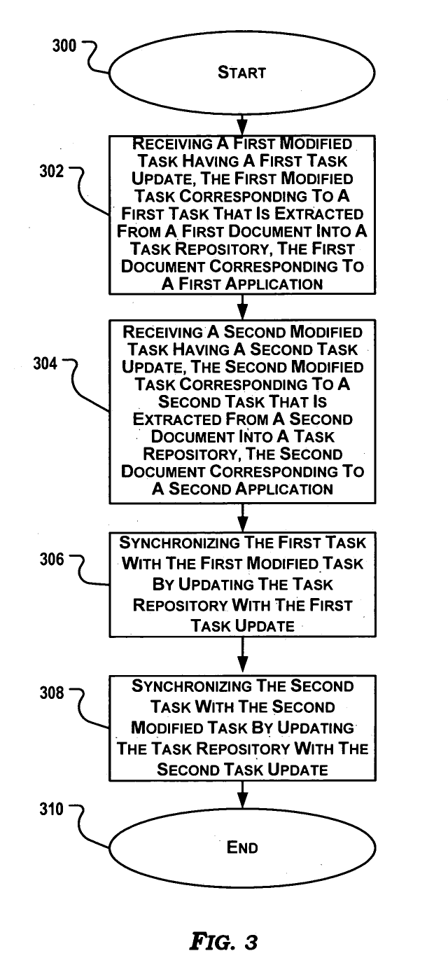

FIG. 3 illustrates that tasks which may be created from various applications, and located in memory 102, may be synchronized with modified tasks. The method begins at block 300, and continues to block 302 where task synchronizer 108 may receive a first modified task having a first task update, where the first modified task may correspond to a first task that is extracted from a first document corresponding to a first application. At block 304, task synchronizer 108 may receive a second modified task having a second task update, where the second modified task may correspond to a second task that is extracted from a second document corresponding to a second application. First and second modified tasks may be created from a document located in memory 110, for example. Also, a task synchronizer that “receives” modified tasks may receive modified tasks in response to an operation initiated by the task synchronizer, and/or may receive modified tasks in response to an operation initiated by other than the task synchronizer, such as a user.

At block 306, task synchronizer 108 may synchronize the first task with the first modified task by updating at least one task repository 104 with the first task update. At block 308, task synchronizer 108 may synchronize the second task with the second modified task by updating the task repository 104 with the second task update. Modified tasks in the task repository 104 may be accessed by applications, and managed using documents, such as documents located in memory 102. The method ends at block 310.

While memory 102 and memory 110 are illustrated as distinct blocks in FIG. 1, it should be understood that this is for illustration purposes only, and memory 102 and memory 110 may comprise a single, physical memory, or more than two physical memories without departing from this embodiment.

As used herein, a “task repository” may mean a machine-readable memory, and may comprise, for example, a hard disk drive, RAM, floppy disk, or any combination thereof. A task repository may comprise a single, physical repository, multiple physical repositories, or a single, logical repository comprising a plurality of physically distributed machine-readable memories. In this respect, a “task” that may be stored in a task repository shall mean that the task may be stored in a single, physical repository, across multiple physical repositories, or in any one of a plurality of physically distributed machine-readable memories that make up a single, logical repository. Furthermore, operations that may be performed on a task repository, or that involve a task repository, may be applicable to one task repository and/or multiple task repositories.

In one embodiment of the invention, tasks may be extracted into at least one task repository including a master task repository, such as illustrated in FIG. 1. A master task repository may be a task repository that may store a master copy of extracted tasks. A master task repository may comprise a single task repository, or multiple task repositories, such that all extracted tasks may be stored in the single task repository or multiple task repositories that make up the master task repositories. In another embodiment of the invention, tasks may be extracted into one or more individual task repositories, where each task repository may store extracted tasks assigned to a given task owner. FIG. 1 also illustrates this latter embodiment, except that only one individual task repository is shown.

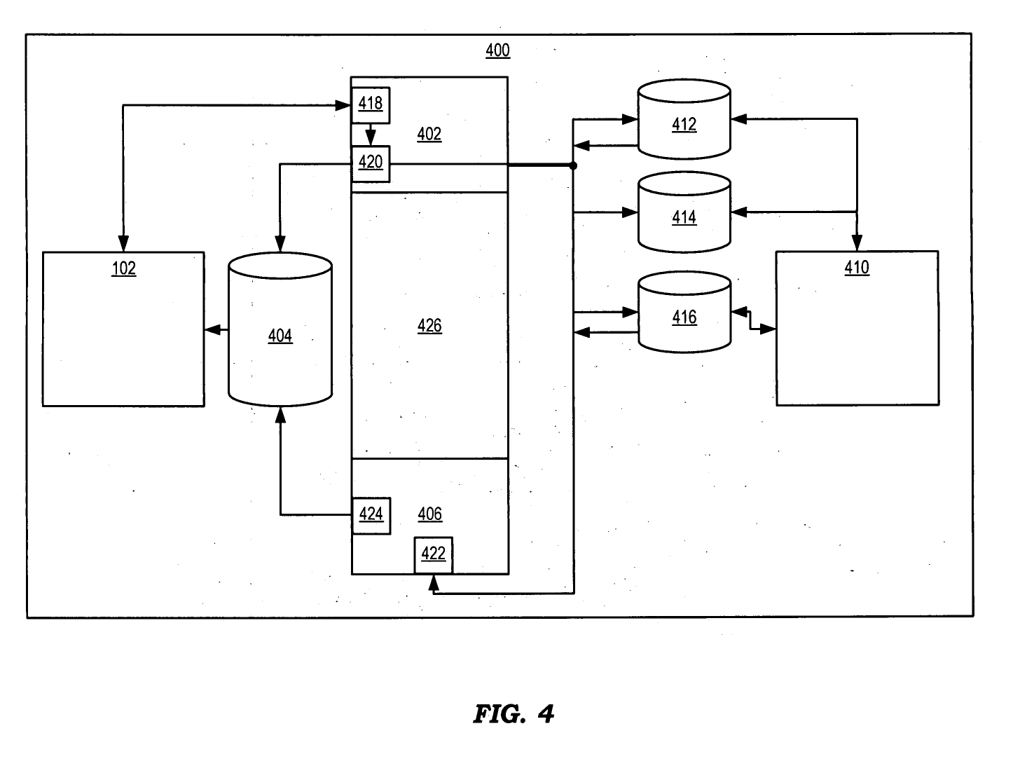

In yet another embodiment of the invention, tasks may be extracted into a master task repository as well as one or more individual task repositories as illustrated in FIG. 4. In this embodiment, a system 400 may comprise a memory 102 to store documents associated with various applications. A first circuit 418 in a task extractor 402 may extract tasks from the documents stored in the memory 102 and a second circuit 420 in the task extractor 402 may store the tasks in a master task repository 404, as well as in individual task-repositories 412, 414, 416. Where both master and individual task repositories are used, individual task repositories may, in one embodiment, act as a local storage location. For example, an individual task repository may be used to store a local copy of modified tasks (to be discussed) such that the modified tasks are visible to a corresponding task owner, and not to other task owners.

Tasks may be modified using, for example, an application. Modified tasks may have associated task updates, where each task update may be associated with a modification of specific task information of a modified task, such as a task due date, or task status. Furthermore, modified tasks may correspond to tasks extracted from documents corresponding to various applications, and, in one embodiment, may be stored in one or more individual task repositories 412, 414, 416. (In embodiments where one or more individual task repositories are not used, modified tasks may be stored in a master task repository 404). A first circuit 422 of the task synchronizer 406 may receive modified tasks from the plurality of individual task repositories 412, 414, 416. A second circuit 424 of the task synchronizer 406 may synchronize the tasks with the modified tasks by updating the master task repository 404 with the task updates. While memory 410 is shown as a separate memory from memory 110, memory 410 and memory 110 may be the same memory for storing documents.

Task extractor 402 and task synchronizer 406 may be separate, individual apparatus 402, 406, or alternatively, they may be integrated into one or more apparatus 426 (only one shown).

### Tasks and Documents

As used herein, a “user” may be a person. A user may include a task creator, and/or a task owner, for example, where a task creator is one who (or that) generates a task, and a task owner is one who (or that) owns a task (such as when a task is assigned to the user), or any other person who may access tasks. Alternatively, or additionally, a user may be a computer. For example, if a task due date passes, a computer may automatically change the status to “Task Due”.

“Extract”, as used herein, may mean obtaining information. For example, a task may be extracted from a document by selecting a task, and withdrawing associated task information. The task information may then be stored in one or more task repositories. “Synchronize”, as used herein, may mean matching some or all portions of information. For example, a task that is synchronized with a modified task may mean that the task information associated with the task is modified to match the task information associated with the modified task.

As used herein, a “document” may mean one or more objects, such as an electronic file and/or a page, comprising data stored thereon. Data in a document, such as task information corresponding to a task, may be accessed using an application. A document may comprise, for example, a database file, an email file, or a word processing file.

In embodiments of the invention, a task may be created and modified using an application. Furthermore, an application may be used to access one or more extracted and/or modified tasks. An “application” as used herein, may mean a computer program and/or tools of the computer program that enable one or more tasks to be accessed, created, modified, accessed, and/or collected. In embodiments of the invention, an application may be used to enter information, access information, and/or modify information, for example, where information may include task information (to be discussed). Examples of applications for creating one or more tasks include Microsoft®Outlook® task utility (hereinafter Outlook®), and Microsoft® Word word processor (hereinafter Word). An example of an application for accessing one, or more tasks may include a directory viewer, such as Windows® Internet Explorer, which may read data from a computer system's hard disk drive, for example, and present a task, for example, as a directory or as a file. Another example is a database query program, which may allow a user to query a database for information, and which may return results to the user via a graphical display, for example.

A “task” as used herein may mean an undertaking that may be electronically created, assigned, modified, and/or viewed. A task may be associated with task information such as a task description, a task owner, and a task due date, for example. Task information may be entered in one or more designated areas of a document. Designated areas of a document may comprise predefined fields. For example, designated areas may comprise a field for a task description, a field for the task owner, a field for the task due date, and a field for the task status, for example. Task information in designated areas may be validated to ensure that the entered task conforms to an appropriate (e.g., predefined) format.

In one embodiment, designated areas may be created using Microsoft's® COM (Component Object Modeling) ADD-IN functionality, for instance. COM ADD-IN allows a Microsoft® application to be extended and enhanced. Using the COM ADD-IN function, one or more fields, such as “Task Description”, “Task Owner”, and “Due Date”, for instance, may be created. COM ADD-IN functionality may be described in “COM Add-ins Part I: Introducing an Office 2000 Solution for the Entire (Office) Family” by Thomas Rizzo, Microsoft Corporation, May 1999; “COM Add-ins Part I: Introducing an Office 2000 Solution for the Entire (Office) Family” by Thomas Rizzo, Microsoft Corporation, May 1999; and/or “COM Add-ins Part II: Building a COM Add-in for Outlook 2000” by Thomas Rizzo, Microsoft Corporation, May 1999. COM ADD-IN functionality may be described in many other articles not mentioned herein, and furthermore, may be implemented in other versions Microsoft® Office 2000, and/or Microsoft® Outlook® 2000.

Another method for creating designated areas it to use SGML (Standard Generalized Markup Language). SGML is a system for organizing and labeling elements of a document. Using SGML, a task creator can create fields for task information by labeling information. For instance, a task description may be labeled with the descriptor <TSK_DSC>; a due date may be labeled with the descriptor <DUE_DATE>; and an owner of the task may be labeled with the descriptor <TSK_OWNER>. By so labeling the data, a computer program can reference the fields delimited by the labels to extract one or more tasks, as will be described.

A user may enter task information in undesignated areas by simply placing a cursor in an undesignated area, and entering information. An undesignated area is any area on a document that is not reserved for specific information. In these embodiments, a program may use crawlers, such as those used in Internet search engines, to determine if a given document has appropriate labels. For example, a custom program may search documents for the label <TSK_DSC>, <DUE_DATE>, or <TSK_OWNER>, and then extract the corresponding task information therefrom.

### Creating a Task

In one or more embodiments, a user, such as task creator, may create tasks in a document. When a task is created, the status may be assigned a status of “incomplete”. Variations of the status incomplete may be used without departing from the scope and spirit of embodiments of the invention. For instance, “new” or “pending” may alternatively, and/or additionally, be used. A task owner may be associated with a name. In cases where the task creator may not know to whom to assign a task, the task creator may designate that the owner is “unknown”. Furthermore, an owner may comprise a group of people, or an entity, for example.

Extracting Tasks

In one embodiment, a task extractor may receive various types of documents. In this embodiment, a task extractor may determine if a document comprises one or more tasks. For example, the task extractor may search for one or more specific labels. If the document has any of these one or more labels, the task extractor may extract the tasks. In another embodiment, a task extractor may only receive documents that comprise one or more tasks. In this embodiment, the task extractor may extract the one or more tasks without the need to determine if the document comprises one or more tasks. A task extractor may extract one or more tasks by selecting a task, locating the task to access the task information, and/or withdrawing the task information. Extracted tasks may be stored by creating a record for each task, where each record may comprise task information.

In an illustrative embodiment, extracted tasks may be stored in a master task repository and one or more individual task repositories. Each individual task repository may correspond to a given task owner, where the task repository may store tasks assigned to, or associated with, the task owner. It is also contemplated that individual task repositories may correspond to that other than a task owner. For example, individual task repositories may correspond to groups of task owners, or task types, for example.

Extracted tasks may be assigned to task owners. A task may be assigned to the owner, for example, by virtue of a task owner being designated in the task information. A task owner may be notified of tasks assigned to the task owner. A notification may be in the form of an email, for example. Furthermore, a notification may comprise task information, such as a task description, task due date, etc. Task owners may be notified at pre-designated times, and/or under a predefined set of conditions. For instance, a task owner may be notified of his/her tasks (new, and/or previously sent), or a manager may be notified of tasks of the manager's reports due on a certain date. The notifications may occur at the close of business each day; every 4 hours; or when at least one task in the task repository has a due date that is less than 2 weeks away, for example. Other notification criteria may be used without departing from the spirit and scope of embodiments of the invention.

Extracted tasks may be exported to a document, or imported into a document. A user, such as a task owner, may manage tasks using an application. A user may modify tasks, for instance, by accessing the tasks in a document, and using an application and the application, tools associated with the document to update task information. For example, a user may use a word processing application to modify a task status, or a task due date. A task in which task information is updated is referred to as a modified task.

An application for accessing documents into which tasks are imported (receiving application) may be the same application as one associated with an application associated with a document from which the tasks originate (originating application). For example, if a task is created in an email via Outlook®, the task may be imported into (or exported to) a Microsoft® Outlook® email. Alternatively, a receiving application may be an application that is different from the originating application. For example, if a task is created in an email via Microsoft® Outlook®, the task may be imported into (or exported to) a Microsoft® Word word processing document.

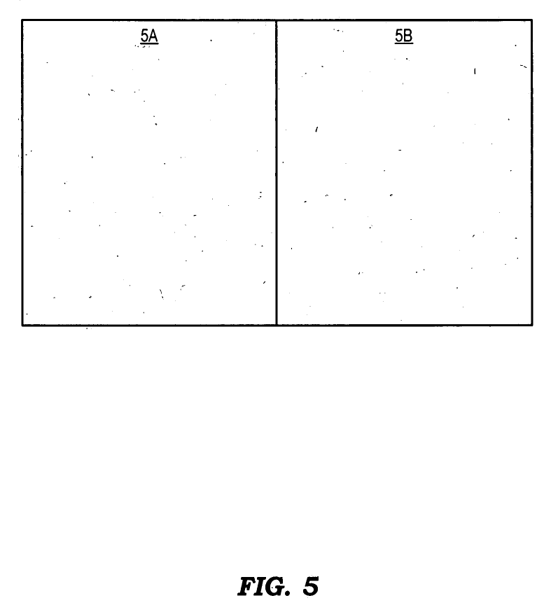

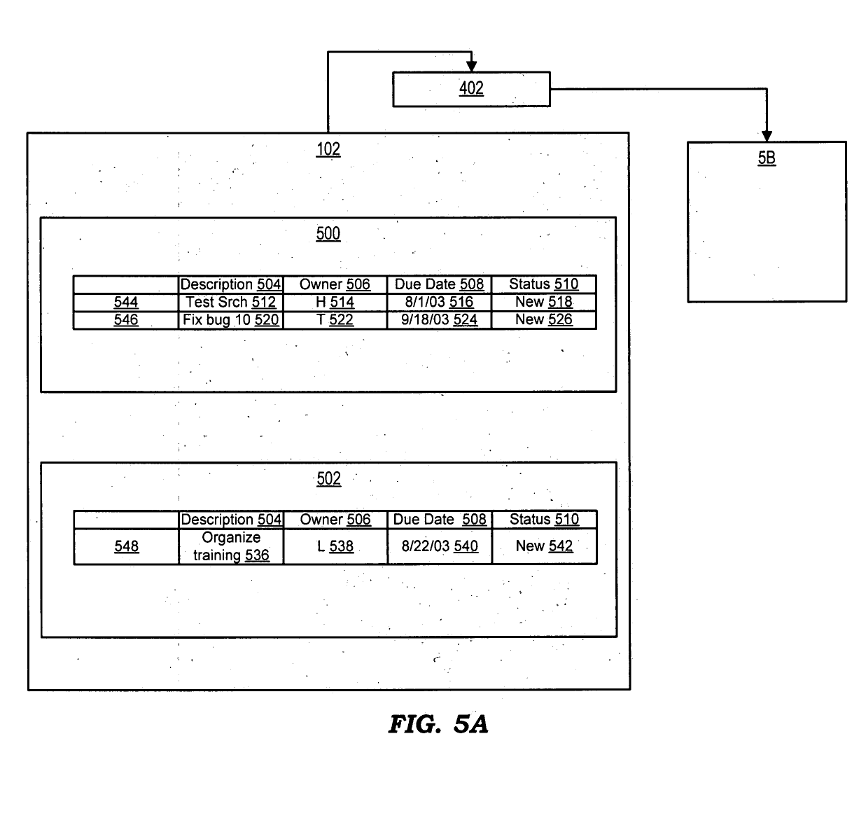

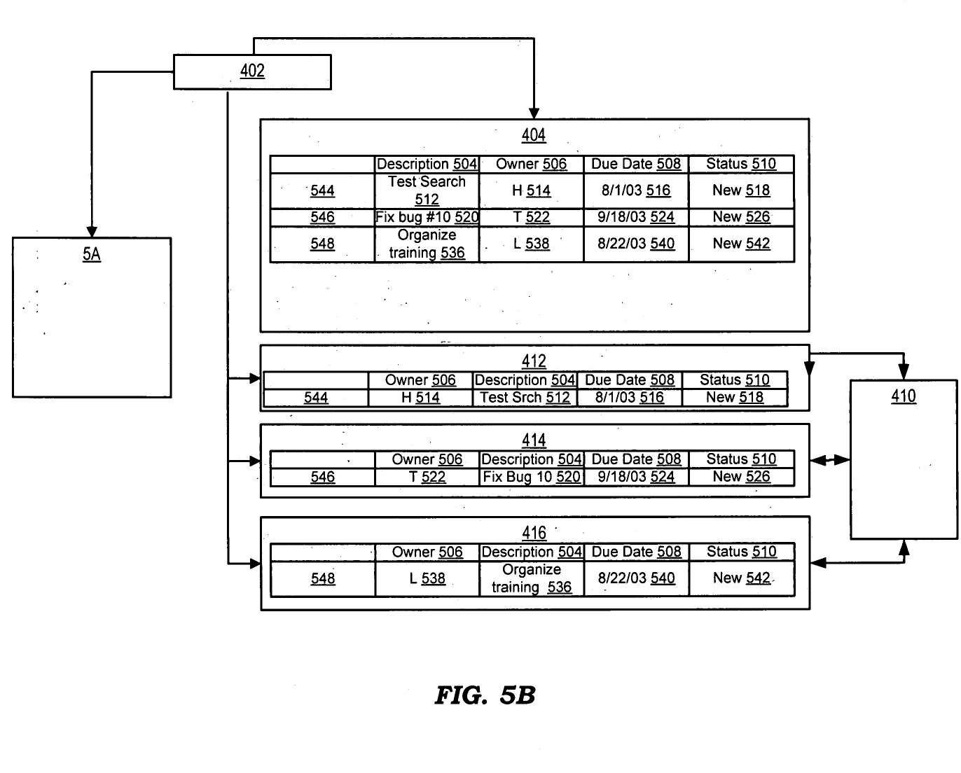

FIGS. 5A and 5B illustrate one embodiment, where FIG. 5 is a smaller scale view showing the whole formed by the partial views of FIGS. 5A and 5B, and which indicates the positions of the parts shown in FIGS. 5A and 5B. As illustrated in FIG. 5A, a memory 102 may comprise documents 500, 502 having tasks 544, 546, 548. Each task 544, 546, 548 may be associated with task information, including (as examples), a description 504 (512, 520, 536, respectively), an owner 506 (514, 522, 538, respectively), a due date 508 (516, 524, 540, respectively), and status 510 (518, 526, 542, respectively).

Task extractor 402 may extract tasks 544, 546, 548 from documents 500, 502 located in memory 102, and as illustrated in FIG. 5B, store them in a master task repository 404. Task extractor 402 may also store tasks in individual task repositories 412, 414, 416. In the illustrated example, each individual task repository 412, 414, 416 corresponds to a task owner, and stores tasks assigned to the given task owner. Thus, individual task repository 412 corresponds to task owner H, so task 544 is stored therein; individual task repository 414 corresponds to task owner T, so task 546 is stored therein; and individual task repository 416 corresponds to task owner L, so task 548 is stored therein. Tasks may be accessed using an application, and managed in a document in memory 410, for example.

Synchronizing Tasks

A task synchronizer 406 may synchronize a task in a task repository with a modified task in accordance with updated task information. Task synchronizer 406 may do this by accessing the record corresponding to the task, and replacing the task information with the updated task information. For example, if a user (such as a task owner) modifies a task by updating its task status, then task synchronizer 406 may synchronize the task with the modified task by accessing the record corresponding to the task, and replacing the current task status with the updated task status.

A task owner may initiate a synchronization. In this embodiment, task synchronizer 406 synchronizes tasks in one or more task repositories with modified tasks. Alternatively, task synchronizer 406 may initiate the synchronization. In one embodiment, task synchronizer 406 may synchronize tasks in accordance with a schedule. This may occur, for instance, where a task synchronizer 406 checks for modified tasks at predesignated times.

Modified tasks may be exported to, or imported into, a document that may be in memory 102. Modified tasks may be further modified. For example, a user (such as a task creator) may change the task due date, or elaborate on the task description. The task may be extracted again in a manner described above for extracting documents.

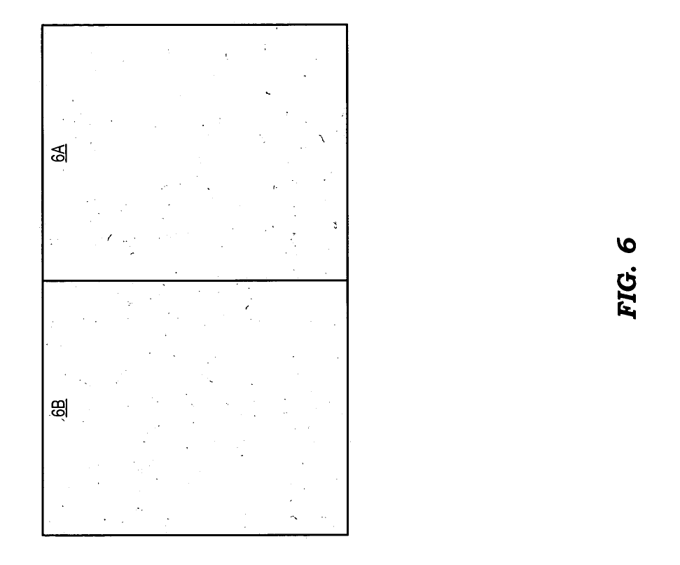

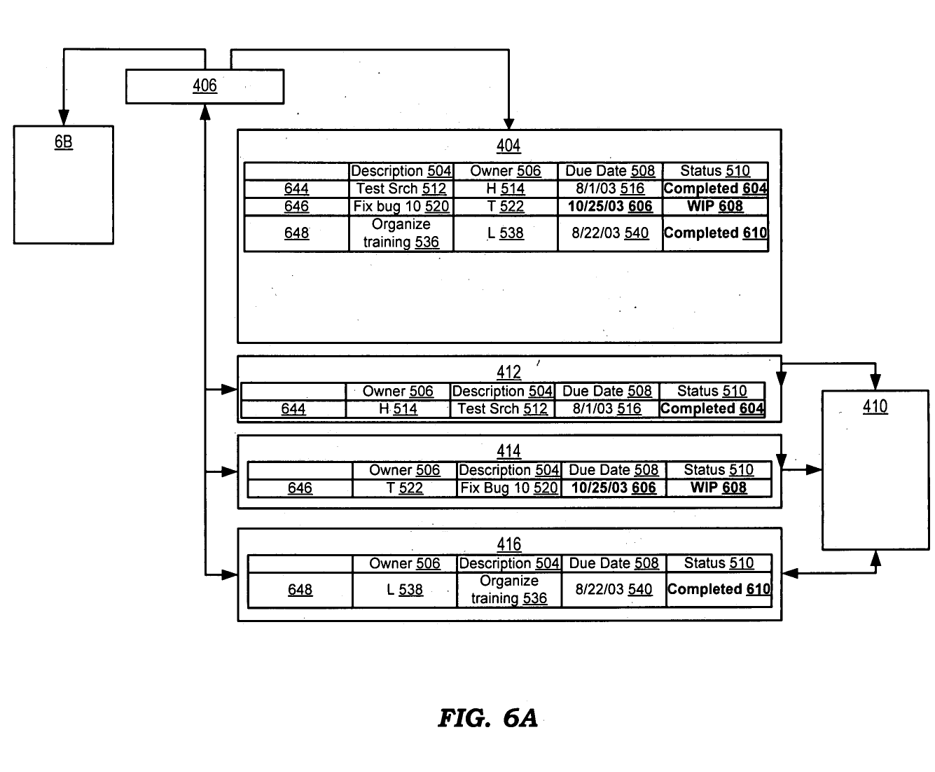

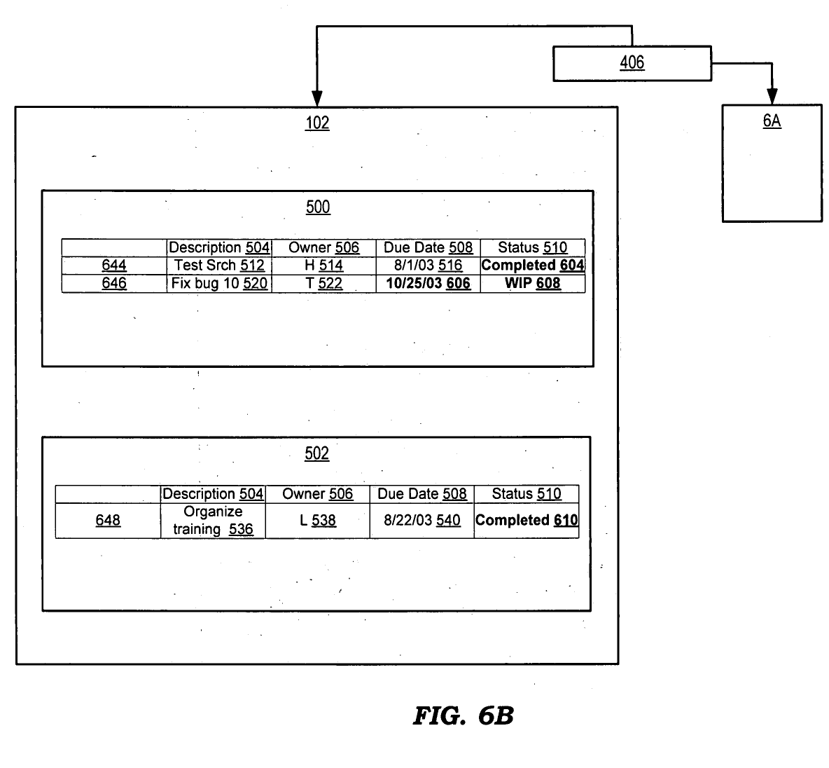

FIGS. 6A and 6B illustrate one embodiment, where FIG. 6 is a smaller scale view showing the whole formed by the partial views of FIGS. 6A and 6B, and which indicates the positions of the parts shown in FIGS. 6A and 6B. As illustrated in FIG. 6A, modified tasks may be received from memory 410. In the illustrated example, tasks 644, 646, and 648 are modified tasks. Task 644 includes updated task information 604 (“Status” 510 changed from “New” 518 to “Completed” 604); task 646 includes updated task information 606 (“Due Date” changed from “Sep. 18, 2003” 524 to “Oct. 25, 2003” 606), and 608 (“Status” 510 changed from “New” 526 to “WIP” 608); and task 648 includes updated task information 610 (“Status” 510 changed from “New” 542 to “Completed” 610).

Task synchronizer 406 may synchronize modified tasks 644, 646, 648 in one or more individual task repositories 412, 414, 416 with tasks in master task repository 404. (While the example illustrates that task synchronizer 406 obtains modified tasks from individual task repositories 412, 414, 416, it is also contemplated that task synchronizer 406 may alternatively, or additionally, obtain modified tasks from documents located in memory 410.) As illustrated in FIG. 6B, modified tasks 644, 646, 648 may be accessed using documents 500, 502 in memory 102.

Conclusion

Thus, one system embodiment comprises a task extractor 106 to extract at least one task from a first document that may be located in memory 102, where the first document may be associated with a first application, and at least one other task from a second document that may be located in memory 102, where the second document may be associated with a second application. The task extractor 106 may store the at least one task and at least one other task in a task repository 104. The system may also comprise a task synchronizer 108 to receive a first modified task having a first task update, where the first modified task may correspond to a first task that is extracted from a first document corresponding to a first application, and a second modified task having a second task update, where the second modified task may correspond to a second task that is extracted from a second document corresponding to a second application. The task synchronizer 108 may synchronize the first task with the first modified task by updating a task repository with the first task update, and may synchronize the second task with the second modified task by updating the repository with the second task update.

The system described herein may facilitate task management by consolidating tasks and/or modified tasks. Tasks created from various applications may be extracted and stored into a task repository, which enables a task owner who may have various tasks assigned to him/her via several applications to import his or her tasks from the task repository into a single document. Tasks may also be synchronized with corresponding modified tasks by updating the task repository with the task updates of the modified tasks. This enables a task creator who may assign tasks via various applications to view task updates from a single document.

In the foregoing specification, specific embodiments have been described. It will, however, be evident that various modifications and changes may be made to these embodiments without departing therefrom. The specification and drawings are, accordingly, to be regarded in an illustrative rather than a restrictive sense.

1. A method comprising:
extracting at least one task from a first document associated with a first application;
extracting at least one other task from a second document associated with a second application; and
storing each of the at least one task and at least one other task in a task repository.

2. The method of claim 1, the method additionally comprising assigning one of the at least one task extracted from the first document to a task owner.

3. The method of claim 2, the method additionally comprising:
receiving a modified task having a task update, the modified task corresponding to the one of the at least one task; and
synchronizing the one of the at least one task with the modified task by updating the one task with the task update.

4. The method of claim 1, the method additionally comprising storing each of the at least one task and at least one other task in a plurality of individual task repositories, wherein each of the plurality of individual task repositories is associated with a task owner, and is to store tasks associated with a respective task owner.

5. A method comprising:
receiving a first modified task having a first task update, the first modified task corresponding to a first task that is extracted from a first document into a task repository, the first document corresponding to a first application;
receiving a second modified task having a second task update, the second modified task corresponding to a second task that is extracted from a second document into the task repository, the second document corresponding to a second application;
synchronizing the first task with the first modified task by updating the task repository with the first task update; and
synchronizing the second task with the second modified task by updating the task repository with the second task update.

6. The method of claim 5, the method additionally comprising updating the first document with the first task update by exporting the first modified task into the first document.

7. The method of claim 6, the method additionally comprising updating the second document with the second task update by exporting the second modified task into the second document.

8. An apparatus comprising:
a first circuit capable of:
extracting at least one task from a first document, the first document being associated with a first application;
extracting at least one other task from a second document, the second document being associated with a second application;
a second circuit capable of storing each of the at least one task and at least one other task in a task repository.

9. The apparatus of claim 8, wherein the second circuit is capable of storing each of the at least one task and at least one other task in a master task repository.

10. The apparatus of claim 9, wherein the second circuit is capable of storing each of the at least one task and at least one other task in at least one additional task repository, the at least one additional task repository including at least one individual task repository associated with a task owner.

11. The apparatus of claim 8, the apparatus additionally comprising a third circuit capable of assigning one or more of the at least one task and at least one other task to at least one task owner.

12. The apparatus of claim 8, further comprising:
a third circuit capable of receiving a modified task having a task update, the modified task corresponding to one of the at least one task; and
a fourth circuit capable of synchronizing the one of the at least one task with the modified task by updating the one of the at least one task with the task update.

13. A system comprising:
a memory to store a plurality of documents each having at least one task;
a master task repository to store the at least one task;
a plurality of individual task repositories each corresponding to a task owner; and
a task extractor to:
extract at least one task from a first document of the plurality of documents, the first document being associated with a first application;
extract at least one other task from a second document of the plurality of documents, the second document being associated with a second application;
store each of the at least one task and at least one other task in the master task repository, and in a corresponding one of the plurality of task repositories.

14. The system of claim 13, the task extractor to additionally assign some of the at least one task and other task to at least one task owner of the at least one task and other tasks.

15. The system of claim 13, additionally comprising a task synchronizer to:
receive a modified task having a task update, the modified task corresponding to one of the at least one task; and
synchronize the one of the at least one task with the modified task by updating the one of the at least one task with the task update.

16. A machine-readable medium having stored thereon instructions, the instructions when executed by a machine, result in the following:
extracting at least one task from a first document, the first document being associated with a first application;
extracting at least one other task from a second document, the second document being associated with a second application;
storing each of the tasks and other tasks in at least one task repository.

17. The machine-readable medium of claim 16, wherein one of the at least one task repository includes a master task repository, and the instructions when executed by the machine additionally result in:
receiving a modified task having a task update, the modified task corresponding to one of the at least one task; and
synchronizing the one of the at least one task with the modified task by updating the one of the at least one task with the task update.

18. The machine-readable medium of claim 16, the instructions when executed by the machine additionally result in assigning some of the at least one task and other task to at least one task owner of the at least one task and other tasks.

19. A machine-readable medium having stored thereon instructions, the instructions when executed by a machine, result in the following:
receiving a first modified task having a first task update, the first modified task corresponding to a first task that is extracted from a first document into a task repository, the first document corresponding to a first application;
receiving a second modified task having a second task update, the second modified task corresponding to a second task that is extracted from a second document into the task repository, the second document corresponding to a second application;
synchronizing the first task with the first modified task by updating the task repository with the first task update; and
synchronizing the second task with the second modified task by updating the task repository with the second task update.

20. The machine-readable medium of claim 19, the instructions when executed by the machine additionally result in updating the first document with the first task update by exporting the-first modified task into the first document.

21. The machine-readable medium of claim 20, the instructions when executed by the machine additionally result in updating the second document with the second task update by exporting the second modified task into the second document.
